(19) United States
(12) Patent Application Publication
(10) Pub. No.: US 2026/0053691 A1
(43) Pub. Date: Feb. 26, 2026

(54) Mobility Support Apparatus

(71) Applicant: John Austin, Ballarat (AU)

(72) Inventor: John Austin, Ballarat (AU)

(21) Appl. No.: 19/104,871

(22) PCT Filed: Aug. 16, 2023
(86) PCT No.: PCT/AU2023/050774

§ 371 Date: Feb. 19, 2025

(30) Foreign Application Priority Data
Aug. 19, 2022 (AU) 2022902368

(51) Int. Cl. A61H 3/02

(52) U.S. Cl. CPC A61H 3/0277; A61H 2003/0205; A61H 2003/0216; A61H 2201/0107; A61H 2201/0157; A61H 2201/0192

(57) ABSTRACT

A mobility support apparatus, comprising: two operatively connected support struts having portions arranged substantially parallel to one another, each strut forming a pair with a corresponding leg for interfacing with the ground; the pair of strut and leg being configured to be slideably moveable relative to each other; and biasing means configured for providing compressive resistance force between the pair of strut and leg, wherein a tension factor of the biasing means is independently adjustable, during use, for each respective pair of strut and leg.

### FIELD OF THE INVENTION

This invention relates to mobility support apparatus and in particular a walking aid in the form of a crutch with adjustable suspension.

### BACKGROUND

Conventional walking aids such as crutches are typically used by a person who has injured one of their legs in order to help them walk. There are several types of crutches including underarm, forearm, platform and knee support crutches. Underarm crutches are the most common and are typically used by a person who has sustained an injury to one of their legs. Underarm crutches commonly have a pad that rests in the armpits and against the ribcage of a user, hand grips that the user holds, and a medium density rubber pad at the ground-contacting end of the crutch that provides some grip and a small amount of damping of the impact force when the crutch is placed on the ground. It is typical for conventional underarm crutches to allow the position of the hand grips and the overall length of the crutch to be adjusted.

A problem with conventional crutches is that they provide only limited shock absorption or damping of the impact each time the crutch bears a user's weight and pushed relative to the ground while in use. This often leads to a jarring sensation, which is transferred to the user through the handles and armpit supports, and leads to discomfort in their wrists, armpits and lateral torso regions. Additionally, conventional crutches are often not suitable for traversing rough terrain, such as uneven brick pavers or gravel walking paths, and rely on a single point of contact with the ground, which can be easily displaced on wet or slippery surfaces. Having only a single point of contact can also lead to problems when walking on inclined or declined surfaces since the area of contact with the ground is reduced.

Therefore, there exists a need for a solution that provides more comfortable crutches that can be used safely on a wide range of terrain. The solution should ideally provide a means for reducing the impact felt by the user that is easily adjustable and can be set such that it is appropriate for the user's weight, height and mobility needs.

The applicant has determined that it would be advantageous to provide an improved mobility support apparatus, which in preferred embodiments, seek to at least in part alleviate the above-identified problems or to offer the public with a useful choice.

### SUMMARY OF THE INVENTION

According to an aspect of the invention, there is provided a mobility support apparatus, comprising: two operatively connected support struts having portions arranged substantially parallel to one another, each strut forming a pair with a corresponding leg for interfacing with the ground; the pair of strut and leg being configured to be slideably moveable relative to each other; biasing means configured for providing compressive resistance force between the pair of strut and leg, wherein a tension factor of the biasing means is independently adjustable, during use, for each respective pair of strut and leg.

In one embodiment, the tension factor of the biasing means is set to be of different values between each respective pair of strut and leg during use.

In one embodiment, the tension factor of the biasing means is incrementally adjustable at predetermined intervals.

In one embodiment, the biasing means operatively couples the pair of strut and leg.

In one embodiment, the biasing means is mounted between upper and lower stop members received in the strut, the upper stop member comprises a projection configured for protruding through any one of predetermined corresponding openings along the strut so as to lock the biasing means in place, and the lower stop member comprises a projection which travels along a corresponding longitudinal slot in the strut, and wherein the leg is coupled to the lower stop member.

In one embodiment, each strut is configured to provide at least four openings in predetermined increments along the strut for receiving corresponding projection of the upper stop member.

In one embodiment, the slot has a length of about 150 mm.

In one embodiment, the leg is detachably coupled to the strut.

In one embodiment, a length of the strut is telescopically adjustable.

In one embodiment, the biasing means is a compression spring. In some embodiments, the compression spring is a linear force spring where the force in the spring is proportional to the distance it has been deformed.

In one embodiment, the apparatus further comprises a cross brace mounted between the respective support struts.

In one embodiment, upper portions of the support struts are configured to curve inwardly so as to substantially converge at a top end portion of the struts.

In one embodiment, the apparatus is a crutch having an armpit rest with a mounting tube coupling the armpit rest to a top end portion of the support struts, and a handgrip mounted between the struts.

In one embodiment, the armpit rest is configured to be rotationally adjustable and height adjustable relative to the support struts.

In one alternative embodiment, the apparatus comprises a grip handle operatively coupled to a top end portion of the support struts.

In other embodiments, the apparatus comprises three or more support struts as described.

While components of the mobility support apparatus will be described below for use in combination with each other in the preferred embodiments of the present invention, it is to be understood by a skilled person that some aspects of the present invention are equally suitable to be used interchangeably between one or more embodiments of the present invention and/or suitable for use as standalone inventions that can be individually incorporated into other mobility support apparatuses, crutches or walking canes not described herein.

The word “about” or “approximately” when used in relation to a stated reference point for a quality, level, value, number, frequency, percentage, dimension, location, size, amount, weight or length may be understood to indicate that the reference point is capable of variation, and that the term may encompass proximal qualities on either side of the reference point. In some embodiments, the word “about” may indicate that a reference point may vary by as much as 30, 25, 20, 15, 10, 9, 8, 7, 6, 5, 4, 3, 2, or 1 percent.

As used herein, the word “substantially” may be used merely to indicate an intention that the term it qualifies should not be read too literally and that the word could mean “sufficiently”, “mostly”or “near enough”for the patentee's purposes.

### DESCRIPTION OF THE DRAWINGS

The invention will now be described by way of non-limiting example only, with reference to the accompanying drawings, in which:

FIG. 1 is a perspective view of a mobility support apparatus in the form of a crutch in accordance with a preferred embodiment of the present invention,

FIG. 2 is a sectional front view of the apparatus of FIG. 1;

FIGS. 3a and 3b show close up sectional views of the suspension system of the apparatus according to an embodiment of the present invention;

FIG. 4 is a sectional close up view of an adjustable hand grip of the apparatus;

FIG. 5 is a sectional close up view of an adjustable armpit rest of the apparatus; and

FIG. 6 is a perspective view of a mobility support apparatus according to another embodiment of the present invention.

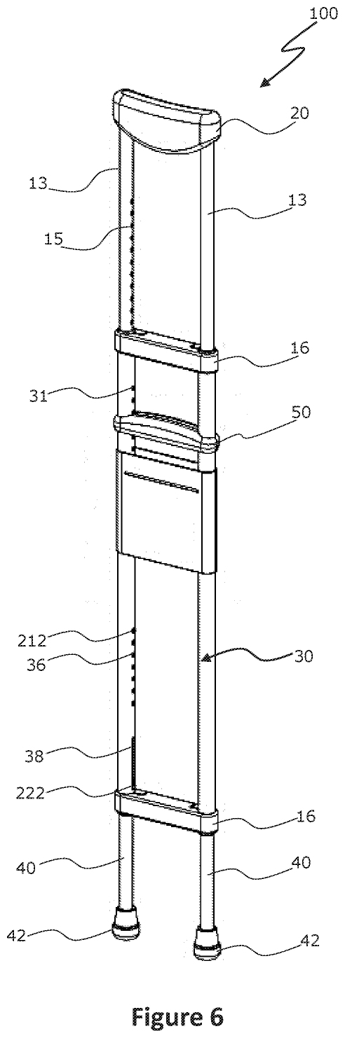

### DETAILED DESCRIPTION

Preferred embodiments of the present invention relates to a mobility support apparatus 100 which could be in the form of a walking aid, a crutch or walking cane for example, having two struts 30 each paired with a leg 40 that is slideably moveable relative to the respective strut 30 (a “strut-leg pair”) and an adjustable suspension system 200 that connects each strut-leg pair. The suspension system 200 is configured to allow the leg 40 to retract within the strut 30 in accordance with a predetermined spring tension value when bearing weight so as to, among others, keep the apparatus substantially level when traversing over uneven surfaces, dampen any jarring sensation when the apparatus 100 is used over rough terrain, provide improved traction between a foot portion 42 of the leg 40 and the ground surface, and, in some cases, also provide propulsive forces to assist the user in taking their next step forward. Each apparatus 100 is provided with at least two struts 30 having corresponding legs 40 and suspension systems 200. In the preferred embodiment, the suspension system 200 between each strut-leg pair is independently adjustable so that each strut-leg pair may be set at a different spring tension value. This is advantageous as, for example in a two-struts 30 apparatus 100, having a front strut-leg pair configured with a spring tension value that is higher than that of a rear strut-leg pair provides the effect of propelling the user forward during the climb up an incline-easing the effort required to walk and thus improving the user's mobility. Walking down an incline, the suspension systems 200 of apparatus 100 can likewise be readily configured to have the front strut-leg pair configured with a lower spring tension value relative to that of the rear strut-leg pair to provide stability and support to bear the user's weight while allowing an easier roll-forward motion of the user's shoulder and body when proceeding down the incline. Therefore, having a suspension system 200 in each of at least two strut-leg pairs in a walking aid and having the ability to independently and easily configure each of the suspension systems 200 in their respective strut-leg pairs of the apparatus 100 provide significant technical advantages and improvements to a user's mobility. Details of the apparatus 100 and its components will now be described below.

In the description herein, certain directional terminology may be used which, unless the context clearly requires otherwise, should be considered with reference to the apparatus 100 as ordinarily used by a user when standing upright.

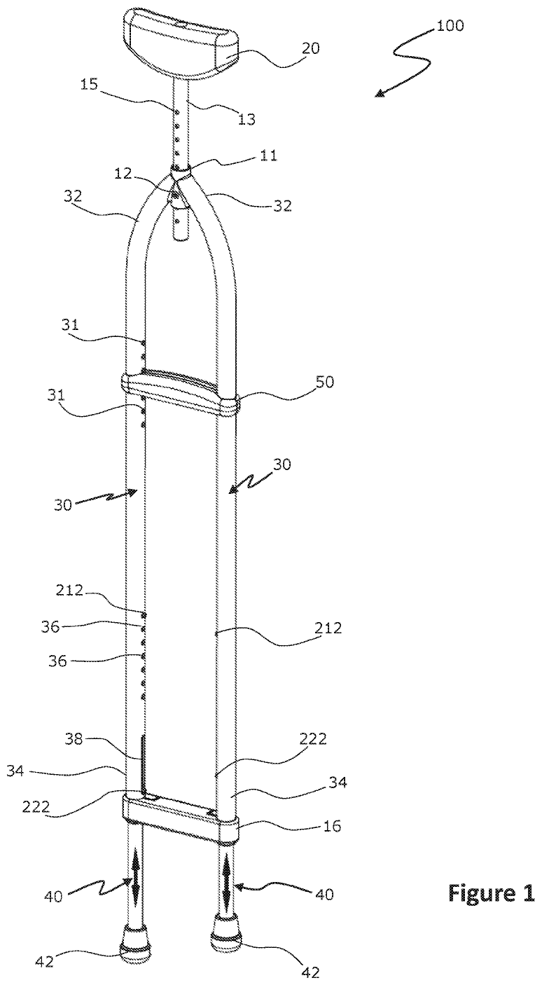

FIG. 1 shows the mobility support apparatus 100 according to a preferred embodiment of the present invention comprising two support struts 30 having portions arranged substantially parallel to one another. Each support strut 30 comprises a main body portion, an upper portion 32 and a lower portion 34. In some embodiments, parts of the upper portions 32 of the struts 30 are configured to curve inwardly so as to substantially converge at a top end portion of the struts 30. In one example, the struts 30 are joined at the top end portion to a tubular member 11. The struts 30 may also be operatively connected to one another by a cross brace 16 and a hand grip 50. It is to be appreciated that the struts 30 may be operatively connected in other equally suitable ways and that the connections are not limited to the examples provided herein. In some embodiments, the length of the strut 30 may be adjusted telescopically. Each leg 40 comprises a ground contact portion 42 for interfacing with the ground. In some cases, the ground contact portion 42 can be made from rubber or other suitable material for providing grip/traction with the ground.

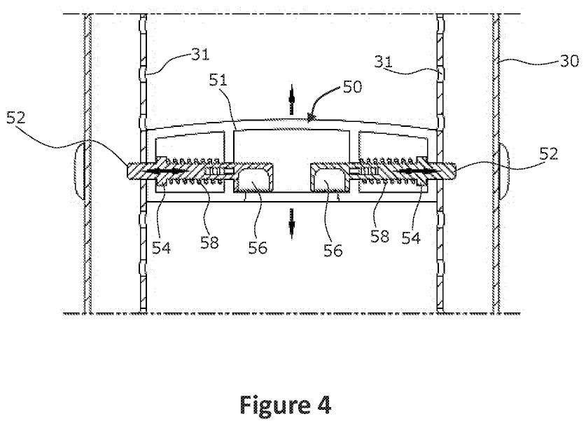

The apparatus 100, when used in the form of a crutch as shown in FIG. 1, further comprises an armpit pad 20 for supporting the body of the user and hand grip 50 to be gripped by the user during use. In the preferred embodiment, the position of the hand grip 50 may be adjusted so that it is closer to, or further away from, the armpit pad 20 such that the user can comfortably position the hand grip 50 relative to the length of their arm. Referring to FIG. 4, the hand grip 50 is substantially in the form of a cross bar having a housing 51 with a central cavity which houses two spring-loaded latches having pins 52 that are received in corresponding alignment openings 31 of the struts 30 for locking the hand grip 50 in position. In one embodiment, each latch comprises a pin 52 which is connected to a member which terminates at an opposing end with a recess 56 for accommodating a user's finger or thumb, and the latch is provided with biasing means in the form of a spring 58 to keep the pin 52 in the extended position and a stop portion 54 to keep the pin 52 in position. The hand grip position can be adjusted by a user pulling or squeezing the latches together so as to retract the pins 52, and moving the grip so that the pins align with any one of other predetermined alignment openings 31 in the strut 30. Releasing the latches will allow the spring 58 to push the pin 52 back through the opening 31 and thus secure the hand grip 50 into position.

In alternative configurations, the hand grip 50 can be secured to the desired position by fastening an end of the hand grip 50 to a corresponding opening or thread of the strut and secure the hand grip 50 in place using a wingnut 12. It is to be understood that the examples described herein for positioning the hand grip 50 are non-limiting and that other means may be equally suitable for use in realising this feature of the apparatus 100. In a preferred embodiment, a plurality of alignment opening 31 are equally spaced along the longitudinal axis of the strut 30 to allow the user to re-adjust the location of the hand grip 50 to a comfortable location.

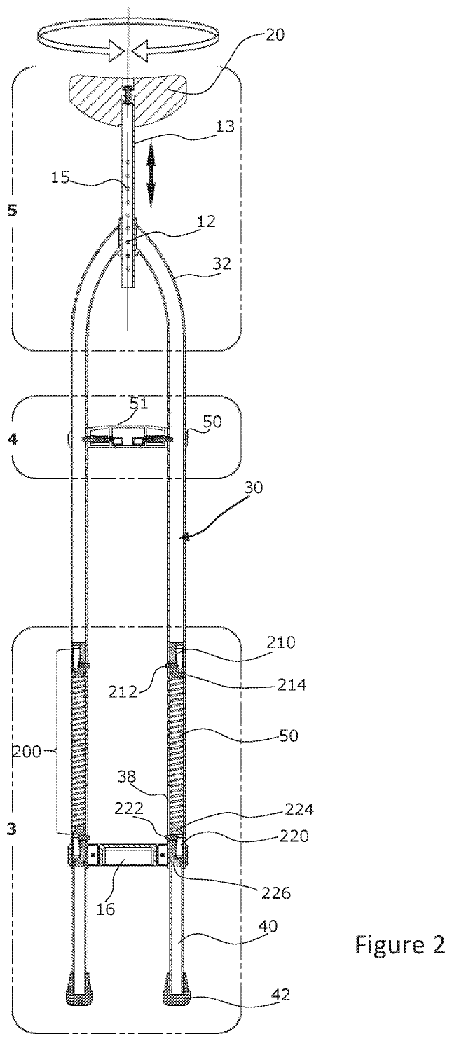

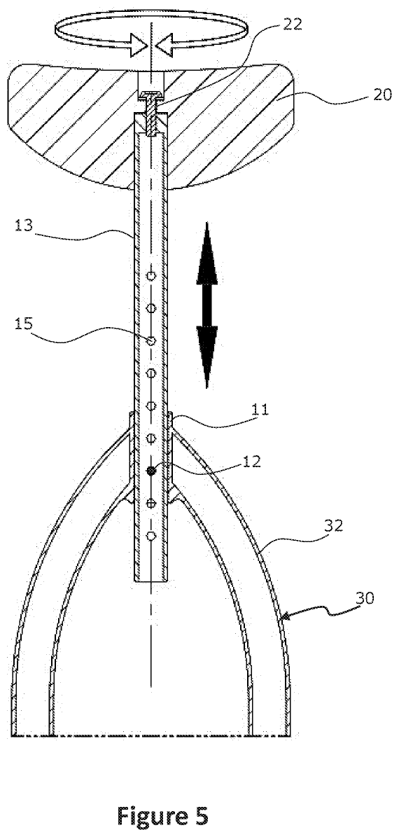

Referring to FIGS. 2 and 5, the armpit pad 20 is mounted to a mounting tube 13, which is coupled to the tubular member 11 joining the top portions 32 of the struts 30. The relative height and position of the armpit pad 20 can be adjusted by fastening 12 the mounting tube 13 at different heights relative to the struts 30 at corresponding predetermined openings 15. The armpit pad 20 may be mounted during a fastener 22 so as to be rotatable about the axis of the mounting tube 13. Allowing the armpit pad 20 to rotate may also be advantageous when navigating uneven terrain and would allow the user to comfortably rotate the crutch to select a suitable area on the ground to place the foot portion 42 of each leg 40. In one configuration, the armpit pad 20 is able to be unpinned allowing the armpit pad 20 to rotate 360 degrees about its axis so as to enable a user to freely rotate the strut-leg pairs, and thus the legs 40, as best suits the terrain. In this way, a user can carefully select the orientation of the front and rear legs 40 of the apparatus to overcome obstacles on the ground.

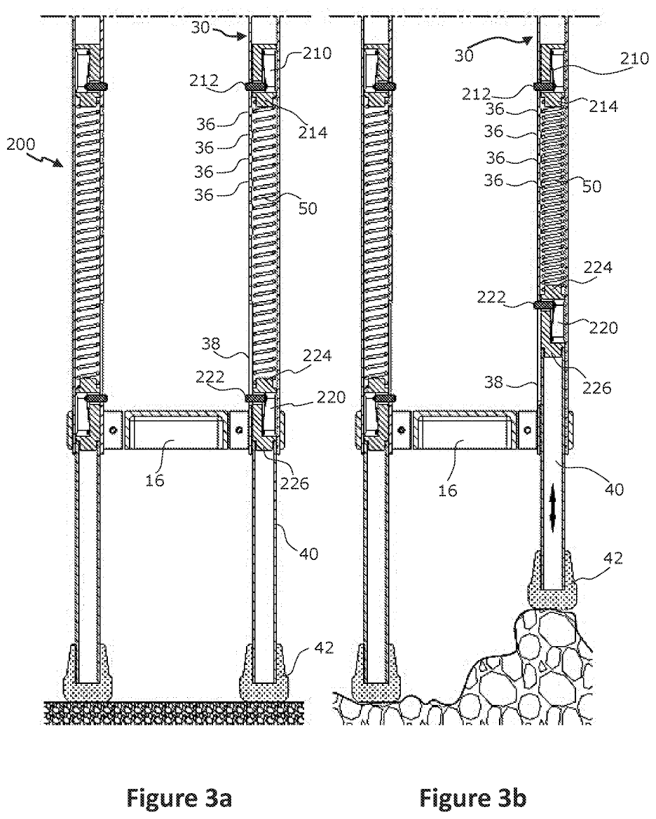

Referring to FIGS. 2, 3(a) and 3(b), each pair of strut 30 and leg 40 (the strut-leg pair) is configured so that the leg 40 is moveable relative to the strut 30. In some embodiments, the leg 40 is dimensioned so that it can be slideably moveable within a tubular cavity of the strut 30. It is to be understood that this relation can be reversed in other embodiments. In the preferred embodiment, the suspension system 200 is located in the lower portion 34 of the strut 30 and operatively couples the strut 30 to the corresponding leg 40. The suspension system 200 is configured to provide compressive resistance force between the strut-leg pair so as to allow some travel of the leg 40 relative to the strut 30 when a loading is placed on the strut 30 (as seen in FIG. 3(a) and 3(b)). This travel of the leg 40 allows the strut 30 of the apparatus 100 and the armpit pad 20 to stay relatively level, even when traversing uneven terrain, as the leg 40 raises relative to the strut 30 when on a raised surface rather than lifting the entire strut 30 in response to the raised surface. Other benefits of the suspension system 200 have been described above.

In the preferred embodiment as shown in the Figures, the suspension system 200 comprises biasing means 50, an upper stop 210 and a lower stop 220, and the biasing means 50 is mounted between the upper stop 210 and the lower stop 220. In one embodiment, the biasing means 50 is in the form of a compression spring, and the spring is operatively secured to mounting points 214, 224 of the respective upper and lower stops 210, 220, which are received within the strut 30 during use. The lower stop 220 is also coupled to the leg 40 so that movement of the leg 40 effects movement of the spring, and vice versa. The upper stop 210 comprises a projection 212 designed for be received through a corresponding opening 36 of the strut for securing the upper stop in place within the lower portion 32 of the strut 30. The strut 30 is provided with a number of predetermined openings 36 to allow adjustability of the upper top 210 relative to the strut 30. The lower stop 220 comprises a projection 222 designed for travelling along a corresponding slot 38 in the strut 30. The slot 38 limits the movement of the projection 222 and hence movement of the lower stop 220 and the associated leg 40 relative to the strut 30. Adjusting the relative positions of the upper stop 210 and the lower stop 220 changes the extension of the compression spring mounted therebetween, and thus a tension factor of the spring which dictates how easily the leg 40 will travel relative to the strut 30 in response to a compressive force loading on the strut 30. In one embodiment, at least four openings 36 are evenly spaced on the strut 30 for receiving projection 212 of the upper stop member 210 so as to allow the user to select at least four levels of compression resistance of the biasing means 50.

In the preferred embodiment, the slot 38 which accommodates the projection 222 of the lower stop 220 is about 150 mm in length. This in effect limits the maximum travel of the attached leg 40 relative to the strut 30, in addition to the effect of the compression spring between the upper stop 210 and the lower stop 220. It is to be understood that the slot length is not intended to be limiting and that other lengths of the slot 38 may also be suitable without departing from the spirit of the invention. While the compression spring has been described to be suitable for use as the biasing means 50, other biasing means not described within may also be suitable without departing from the spirit of the invention.

One method to conveniently adjust the compression force tension factor of the biasing means 50 of the suspension system 200 is to depress both projections 212 and 222 so that they are no longer engaged or confined to the opening 36 or the slot 38. The suspension system 200 and the attached leg 40 can then be pulled out of the strut, and slideably re-inserted to reposition the projection 212 of the upper stop 210 to a desired opening 36 of the strut 30. In one embodiment, the projections 212, 222 are in the form of pins mounted on respective leaf springs biased to keep the projections 212, 222 engaged. It is to be appreciated that other forms of projections will also be suitable for locking the upper stop 210 and lower stop 220 members to the strut 30.

It is to be understood that the suspension system 200 allows the user to adjust the resistance force of the biasing means 50 (compression spring) by varying its length. Advantageously, the suspension system 200 in the preferred embodiment allows the user to adjust the resistance force of the compression spring 50 independently in each of the strut-leg pairs so that the strut-leg pairs may be set at different lengths or spring tension. This is advantageous as described above as having front strut-leg pair and rear strut-leg pair configured with different spring tension could greatly improve the mobility of the user when traversing uphill or downhill environments.

In a preferred embodiment, the biasing means 50 is configured as a linear force spring that obeys Hooke's law, wherein the force of the spring is proportional to the distance that it has been deformed. In other embodiments, the biasing means 50 may be a variable pitch spring wherein the spring rate (N/mm) is not proportional to the distance of deformation. For example, the biasing means 50 can be designed to provide a resistance force that non-linearly increases or decreases with adjustments of the suspension system 200. The biasing means 50 may be designed such that the spring resistance quadratically increases with increasing deflection when the compression spring 50 is compressed by the weight force of the user while in use. In such case, the user would feel the spring resistance becoming increasingly firm as they push down on the crutch. This feature advantageously increases support and comfort for the user during use.

Preferably, the apparatus 100 has two or more strut-leg pairs with the leg 40 being moveable relative to the respective strut 30 and independent of the other leg(s) 40. The compression-extension action provided by the suspension system for the two or more strut-leg pairs advantageously provides the user with a comfortable rolling sensation while walking and decreases the jarring caused by the impact when the leg(s) 40 contact the ground.

The struts 30 and legs 40 can be substantially formed from a stiff and light material such as aluminium, for example. The person skilled in the relevant art would appreciate that aluminium tubes are commonly used for conventional crutches.

In an alternative embodiment, the spring tension of the biasing means 50 of two or more strut-leg pairs may be adjusted at the same time. For example, a centrally locking bar may be provided between the struts 30 with projections that protrude into corresponding openings 36 of the struts 30. The locking bar may be provided with spring loaded latches that are coupled to actuate the projections for adjusting and securing stop members coupled to the biasing means 50.

In further embodiments, instead of an armpit pad 20, the apparatus 100 may be provided with a grip handle operatively coupled to a top end portion of the support struts 30 so as to function as a walking cane.

The apparatus 100 may also be provided with a carry pouch that is removably attachable to a portion of the struts 30 below the hand grip 50 using a hook and loop fastener. It would be appreciated by the person skilled in the relevant art that other suitable fastening means, such as press-studs, can also be used. In a preferred embodiment, the carry pouch comprises a net-like material to allow the user to carry a drink bottle or other small item.

In the description and drawings of this embodiment, same reference numerals are used as have been used in respect of the first embodiment, to denote and refer to corresponding features.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A mobility support apparatus, comprising:
two operatively connected support struts having portions arranged substantially parallel to one another, each strut forming a pair with a corresponding leg for interfacing with the ground;
the pair of strut and leg being configured to be slideably moveable relative to each other; and
biasing means configured for providing compressive resistance force between the pair of strut and leg, wherein a tension factor of the biasing means is independently adjustable, during use, for each respective pair of strut and leg.

2. The mobility support apparatus according to claim 1, wherein the tension factor of the biasing means is set to be of different values between each respective pair of strut and leg during use.

3. The mobility support apparatus according to claim 1, wherein the tension factor of the biasing means is incrementally adjustable at predetermined intervals.

4. The mobility support apparatus according to claim 1, wherein the biasing means operatively couples the pair of strut and leg.

5. The mobility support apparatus according to claim 1, wherein the biasing means is mounted between upper and lower stop members received in the strut, the upper stop member comprises a projection configured for protruding through any one of predetermined corresponding openings along the strut so as to lock the biasing means in place, and the lower stop member comprises a projection which travels along a corresponding longitudinal slot in the strut, and wherein the leg is coupled to the lower stop member.

6. The mobility support apparatus according to claim 5, wherein each strut is configured to provide at least four openings in predetermined increments along the strut for receiving corresponding projection of the upper stop member.

7. The mobility support apparatus according to claim 5, wherein the slot has a length of about 150 mm.

8. The mobility support apparatus according to claim 1, wherein the leg is detachably coupled to the strut.

9. The mobility support apparatus according to claim 1, wherein a length of the strut is telescopically adjustable.

10. The mobility support apparatus according to claim 1, wherein the biasing means is a compression spring.

11. The mobility support apparatus according to claim 10, wherein the compression spring is a linear force spring where the force in the spring is proportional to the distance it has been deformed.

12. The mobility support apparatus according to claim 1, further comprising a cross brace mounted between the respective support struts.

13. The mobility support apparatus according to claim 1, wherein upper portions of the support struts are configured to curve inwardly so as to substantially converge at a top end portion of the struts.

14. The mobility support apparatus according to claim 1, wherein the apparatus is a crutch having an armpit rest with a mounting tube coupling the armpit rest to a top end portion of the support struts, and a handgrip mounted between the struts.

15. The mobility support apparatus according to claim 14, wherein the armpit rest is configured to be rotationally adjustable and height adjustable relative to the support struts.

16. The mobility support apparatus according to claim 1, wherein the apparatus comprises a grip handle operatively coupled to a top end portion of the support struts.

17. The mobility support apparatus according to claim 1, wherein the apparatus comprises three or more support struts as described.
